(19) United States
(12) Patent Application Publication
(10) Pub. No.: US 2026/0048519 A1
(43) Pub. Date: Feb. 19, 2026

(54) SPEED-ADJUSTABLE MAGNETIC LEVITATION MOTOR AND HAIR TRIMMER INCLUDING THE MOTOR

(71) Applicant: Dongguan Kede Precision Manufacturing Co., Ltd., Dongguan (CN)

(72) Inventors: JUN LIU, Dongguan (CN); YOUCHUN YAN, Dongguan (CN)

(21) Appl. No.: 18/980,016

(22) Filed: Dec. 13, 2024

(30) Foreign Application Priority Data
Aug. 13, 2024 (CN) 202411104937.3

(51) Int. Cl. B26B 19/28; B26B 19/06; H02N 15/00

(52) U.S. Cl. CPC B26B 19/28; H02N 15/00; B26B 19/06

(57) ABSTRACT

Disclosed are a speed-adjustable magnetic levitation motor and a hair trimmer including the motor, the magnetic levitation motor includes an elastic force adjustment device, an outer mover, and an inner mover, a magnetic pole of a lower end of the outer mover is arranged opposite to that of a lower end of the inner mover, the elastic force adjustment device is fixedly arranged on the outer mover, the elastic force adjustment device includes an elastic member, a coefficient adjustment member, and an elastic force support member, the coefficient adjustment member is detachably connected to the elastic force support member, one end of the elastic member abuts against the inner mover, the one end thereof abuts against the coefficient adjustment member, and a pressure value of elastic member can be adjusted by adjusting a distance between the coefficient adjustment member on the elastic force support member and the outer mover.

### CROSS-REFERENCE TO RELATED APPLICATIONS

This application claims priority to Chinese Patent Application No. 202411104937.3, filed on Aug. 13, 2024, which is hereby incorporated by reference in its entirety.

### TECHNICAL FIELD

The present disclosure belongs to the field of motors, and particularly relates to a speed-adjustable magnetic levitation motor and a hair trimmer including the motor.

### BACKGROUND

An electric tool, such as a hair clipper and a shaver, usually requires a motor to drive a blade to move back and forth at a high frequency, so as to cut hair. At present, the commonly used motor is an electromagnetic vibration motor, which has the following defects in use:

1. Inability to adjust a swing speed, therefore, different compression springs with different elastic values need to be replaced to achieve different swing speeds. However, replacement of the springs will result in a larger accuracy error of the swing speed, and it is impossible to achieve precise control of the swing speed. Furthermore, since four springs are arranged for the motor, the error will become larger, various springs with different elastic coefficients need to be adjusted repeatedly to achieve an ideal swing speed.

2. Since two sets of movers are arranged in a vertical distribution, the motor will suffer lateral torsional vibrations during operation, resulting in poor experience in using a finished product.

### SUMMARY

### (1) Technical Problem to be Solved

In view of defects in the prior art, the present disclosure is to provide a speed-adjustable magnetic levitation motor and a hair trimmer including the motor, aiming at solving the technical problems in the prior art that various springs with different elastic coefficients needs to be debugged repeatedly when a speed of the motor is adjusted, which is time-consuming and labor-intensive.

### (2) Technical Solution

A speed-adjustable magnetic levitation motor includes an elastic force adjustment device, an outer mover, and an inner mover, a magnetic pole of a lower end of the outer mover is arranged opposite to that of a lower end of the inner mover, and the elastic force adjustment device is fixedly arranged on the outer mover; and the elastic force adjustment device includes an elastic member, a coefficient adjustment member, and an elastic force support member, the coefficient adjustment member is detachably connected to the elastic force support member, one end of the elastic member abuts against the inner mover, the other end of the elastic member abuts against the coefficient adjustment member, and a pressure value of elastic member can be adjusted by adjusting a distance between the coefficient adjustment member on the elastic force support member and the outer mover.

Further, a first coefficient adjustment hole is formed on the elastic force support member, and the coefficient adjustment member adjusts a distance between the coefficient adjustment member on the elastic force support member and the outer mover through the first coefficient adjustment hole.

Further, two outer movers are provided, the inner mover is arranged between the two outer movers, the inner mover is provided with a first abutment position, the elastic force support member is provided with a second abutment position, elastic force fixing holes are formed on both sides of the second abutment position, and an elastic force fixing groove is formed on the outer mover.

Further, the inner mover includes an inner swinging member, the outer mover includes an outer swinging member, a moving blade is arranged on an upper end of the inner swinging member, a sum of weights of the moving blade and the inner mover is balanced against a sum of weights of the two outer movers and the two elastic force adjustment devices.

Further, a stator device is arranged below the inner mover, the stator device includes a bottom bracket, a coil, a stator, and a main bracket, the inner mover and the outer mover are provided with a bias swing limit member and a bias swing limit rod, the inner swinging member is provided with an inner output shaft, the outer swinging member is provided with an outer output shaft, two elliptical holes are symmetrically formed on two ends of the bias swing limit member, and the main bracket is provided with a limit fixing hole and a first limit swing zone.

Further, the inner mover further includes an inner bracket, the outer mover further includes an outer bracket, the outer bracket is provided with an outer avoidance groove, the outer bracket is further provided with a second limit swing zone, the first limit swing zone corresponds to the second limit swing zone and the outer avoidance groove in a vertical direction, the inner swing member is fixedly arranged inside or above the inner bracket, the outer swing member is fixedly arranged inside or above the outer bracket, and the outer bracket and the inner bracket are both made of stainless steel with a thickness of ≤1.2 mm.

Further, both sides of the outer mover and the inner mover are provided with spring pieces, two spring pieces are provided, each of the spring pieces includes an inner spring plate and an outer spring plate, an upper end of the inner spring plate is fixedly connected to the inner bracket, and an upper end of the outer spring plate is fixedly connected to the outer bracket.

Further, the inner mover further includes an inner magnetic yoke, a first inner magnet and a second inner magnet, and the outer mover further includes an outer magnetic yoke, a first outer magnet and a second outer magnet, the inner magnetic yoke; and the first inner magnet and the second inner magnet are fixedly arranged at a lower end of the inner swinging member, the outer magnetic yoke, the first outer magnet and the second outer magnet are fixedly arranged at a lower end of the outer swinging member, magnetic poles of the first inner magnet and the first outer magnet are opposite, and magnetic poles of the second inner magnet and the second outer magnet are opposite.

A hair trimmer, comprising the speed-adjustable magnetic levitation motor stated in any of the above items, a moving blade is arranged on an upper end of the inner swinging member, a total weight of the moving blade is set to C, a total weight of the inner mover is set to D, and an absolute value of (C-D)/C is ≤⅕; a sum of weights of the moving blade and the inner mover is set to A, a sum of weights of the two outer movers and the two elastic force adjustment devices is set to B, and an absolute value of (A-B)/A is ≤⅕.

Further, two second coefficient adjustment holes are formed on the hair trimmer, and the two second coefficient adjustment holes correspond to but do not come into contact with the two elastic force adjustment devices respectively.

Further, a coefficient adjustment protection switch and a coefficient adjustment gear are arranged on the second coefficient adjustment holes.

### (3) Beneficial Effects

Compared with the prior art, the present disclosure has the beneficial effects:

1. When the user has different requirements for the swing speeds of the inner mover and the outer mover, the present disclosure can adjust the swing speeds of the inner mover and the outer mover by adjusting the distance between the coefficient adjustment member on the elastic force support member and the outer mover, such that the elastic member between the coefficient adjustment member and the inner mover is in a compressed state with different extents of tightness, and a pressure value of elastic member is adjusted. The structure can realize the adjustment of the pressure value of the elastic member to change a swing speed of a motor by rotating the coefficient adjustment member on each side, with no need to replace compression springs with different elastic values to adapt to different swing speeds, which greatly improves the accuracy of swing speed adjustment.

2. A sum of weights of the moving blade and the inner mover is balanced against a sum of weights of the two outer movers and the two elastic force adjustment devices, which can prevent lateral torsional vibrations caused by weight imbalance during operation of the moving blade driven by the inner mover, stabilizing a vibration frequency and improving user experience.

3. When replacement of the moving blade results in weight imbalance, the coefficient adjustment member with different lengths can be replaced to maintain relative weight balance and reduce overall vibration of the motor.

### BRIEF DESCRIPTION OF DRAWINGS

FIG. 1 is a first three-dimensional structural diagram of a motor according to the present disclosure.

FIG. 2 is a second three-dimensional structural diagram of a motor according to the present disclosure.

FIG. 3 is an exploded view of a motor according to the present disclosure.

FIG. 4 is a three-dimensional structural diagram of an inner mover and an outer mover being arranged above a stator device according to the present disclosure.

FIG. 5 is a schematic diagram of setting of magnetic poles of a first inner magnet, a second inner magnet, a first outer magnet and a second outer magnet according to the present disclosure.

FIG. 6 is a three-dimensional structural diagram of an inner mover and an outer mover moving away from each other according to the present disclosure.

FIG. 7 is a schematic diagram of actions of a first inner magnet and a second inner magnet in FIG. 6 under an influence of a magnetic field according to the present disclosure.

FIG. 8 is a schematic diagram of actions of a first outer magnet and a second outer magnet in FIG. 6 under an influence of a magnetic field according to the present disclosure.

FIG. 9 is a schematic diagram of relative positions of an inner mover and an outer mover in static states without operation according to the present disclosure.

FIG. 10 is a first schematic diagram of relative positions of an inner mover and an outer mover during operation according to the present disclosure.

FIG. 11 is a second schematic diagram of relative positions of an inner mover and an outer mover during operation according to the present disclosure.

FIG. 12 is a three-dimensional structural diagram of a motor installed on a hair trimmer according to the present disclosure.

Reference numerals in the accompanying drawings: 100. motor; 200. hair trimmer; 1. elastic force adjustment device; 11. elastic member; 12. coefficient adjustment member; 13. elastic force support member; 131. first coefficient adjustment hole; 132. second abutment position; 133. elastic force fixing hole; 2. outer mover; 21. elastic force fixing groove; 22. outer swinging member; 23. outer bracket; 24. outer magnetic yoke; 25. first outer magnet; 26. second outer magnet; 27. second limit swing zone; 28. outer avoidance groove; 29. outer output shaft; 3. inner mover; 31. first abutment position; 32. inner swinging member; 33. inner bracket; 34. inner magnetic yoke; 35. first inner magnet; 36. second inner magnet; 37. inner output shaft; 4. moving blade; 5. stator device; 51. bottom bracket; 52. coil; 53. stator; 54. main bracket; 541. limit fixing hole; 542. first limit swing zone; 61. bias swing limit member; 62. bias swing limit rod; 63. elliptical hole; 7. spring piece; 71. inner spring plate; 72. outer spring plate; and 8. second coefficient adjustment hole.

### DESCRIPTION OF EMBODIMENTS

The technical solutions of embodiments of the present disclosure will be described below clearly and comprehensively in conjunction with accompanying drawings of the embodiments of the present disclosure.

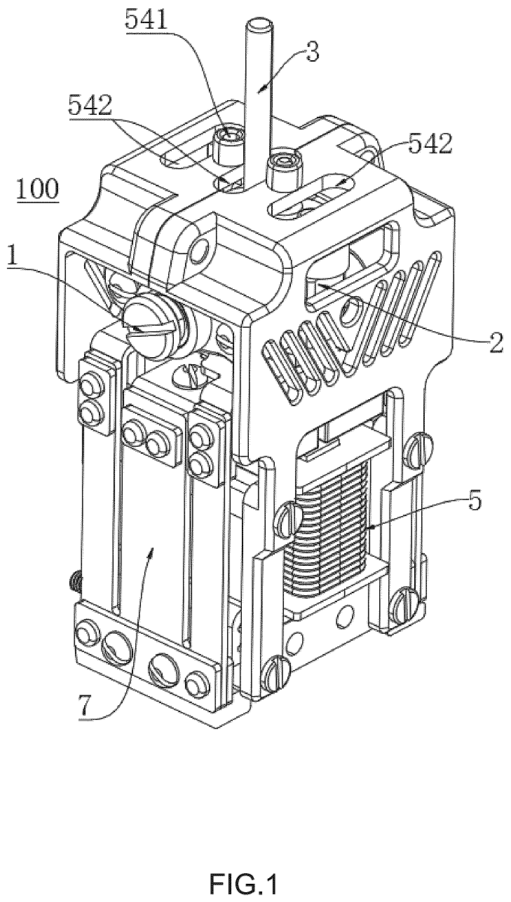

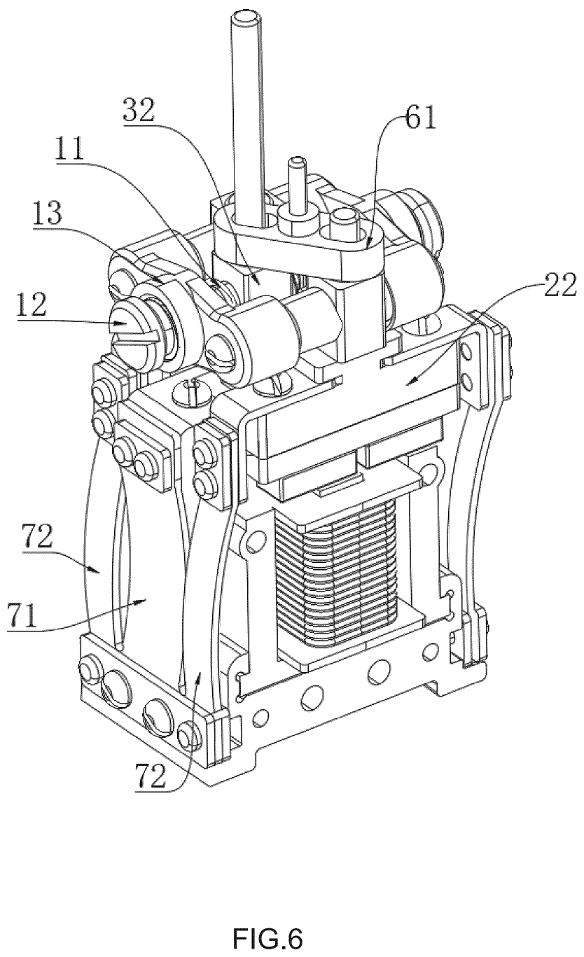

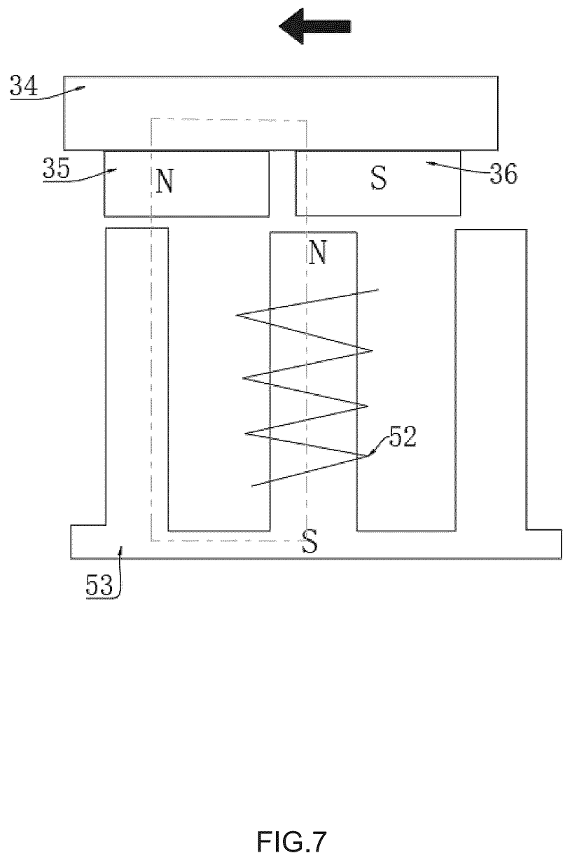

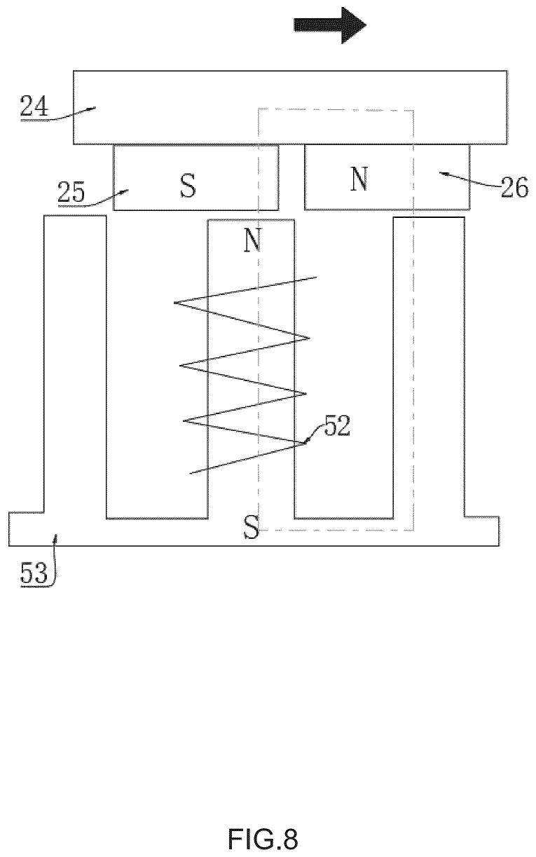

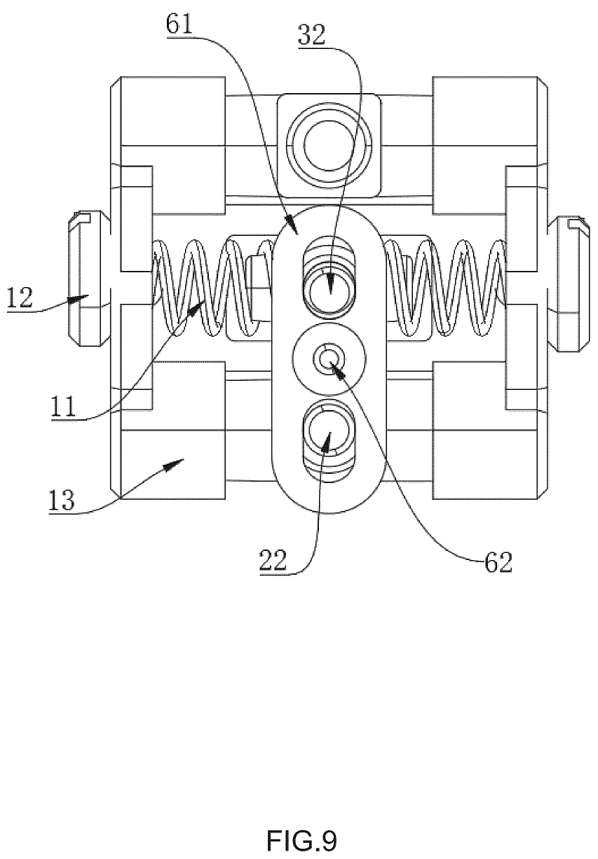

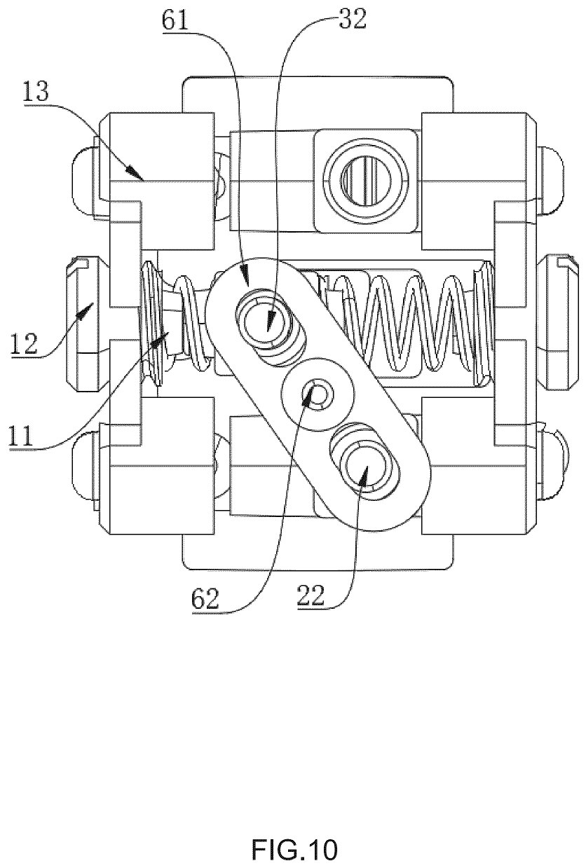

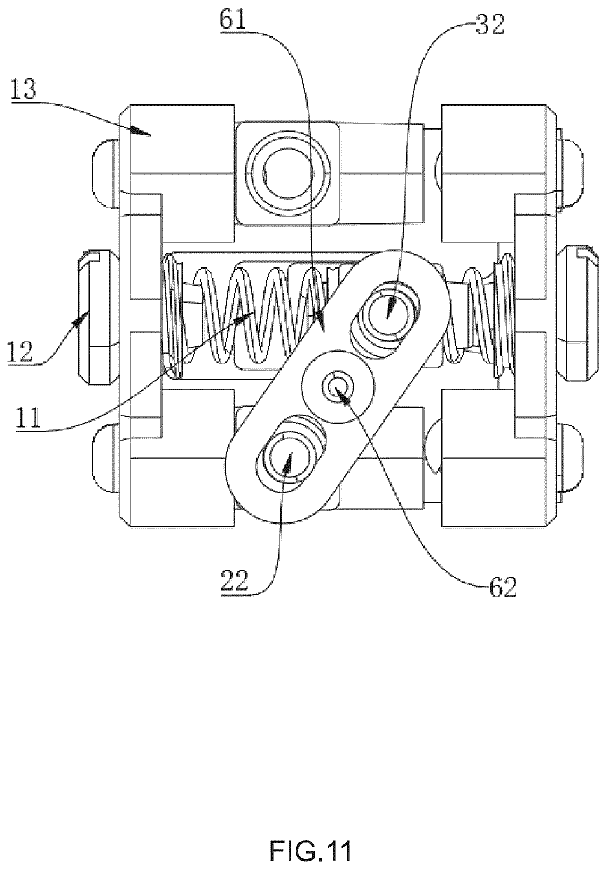

With reference to FIGS. 1-12.

As shown in FIGS. 1-11, the present disclosure provides a speed-adjustable magnetic levitation motor, including an elastic force adjustment device 1, an outer mover 2, and an inner mover 3, where the elastic force adjustment device 1 is fixedly arranged on the outer mover 2, a stator device 5 is arranged below the inner mover 3, magnetic poles at lower ends of the outer mover 2 and the inner mover 3 are arranged with opposite polarities, spring pieces 7 are arranged on both sides of the outer mover 2 and the inner mover 3 to limit the reciprocating swing of the outer mover 2 and the inner mover 3; the elastic force adjustment device 1 includes an elastic member 11, a coefficient adjustment member 12, and an elastic force support member 13; the coefficient adjustment member 12 is detachably connected to the elastic force support member 13, a first coefficient adjustment hole 131 is formed on the elastic force support member 13, the coefficient adjustment member 12 is detachably connected to the elastic force support member 13 through the first coefficient adjustment hole 131, one end of the elastic member 11 abuts against the inner mover 3, and the other end of the elastic member abuts against the coefficient adjustment member 12. Generally, when the stator device 5 generates a magnetic field, the outer mover 2 and the inner mover 3, due to their opposite polarities, perform high-speed reciprocal movements in opposite directions relative to the stator device 5, and the swing speed (that is, a swing frequency of the movers) by detecting a pressure of the elastic member 11 on the outer mover 2 and/or the inner mover 3. For example, when a pressure of the coefficient adjustment member 12 on the elastic member 11 is tightened, the swing speed is accelerated; when the pressure of the coefficient adjustment member 12 on the elastic member 11 is loosen, the swing speed is slowed down; when a user has different requirements for swing speeds of the inner mover 3 and the outer mover 2, it is necessary to replace the elastic member 11 with different elastic force values, which is cumbersome. However, in this embodiment, a distance between the coefficient adjustment member 12 on the elastic force support member 13 and the outer mover 2 can be adjusted, such that the elastic member 11 between the coefficient adjustment member 12 and the inner mover 3 is in a compressed state with different extents of tightness, and a pressure value of elastic member 11 is adjusted to adjust the swing speeds of the inner mover 3 and the outer mover 2. The structure can realize the adjustment of the pressure value of the elastic member 11 to change a swing speed of a magnetic levitation motor 100 by rotating the coefficient adjustment member 12 on each side, with no need to replace compression springs with different elastic values to adapt to different swing speeds, which greatly improves the accuracy of swing speed adjustment.

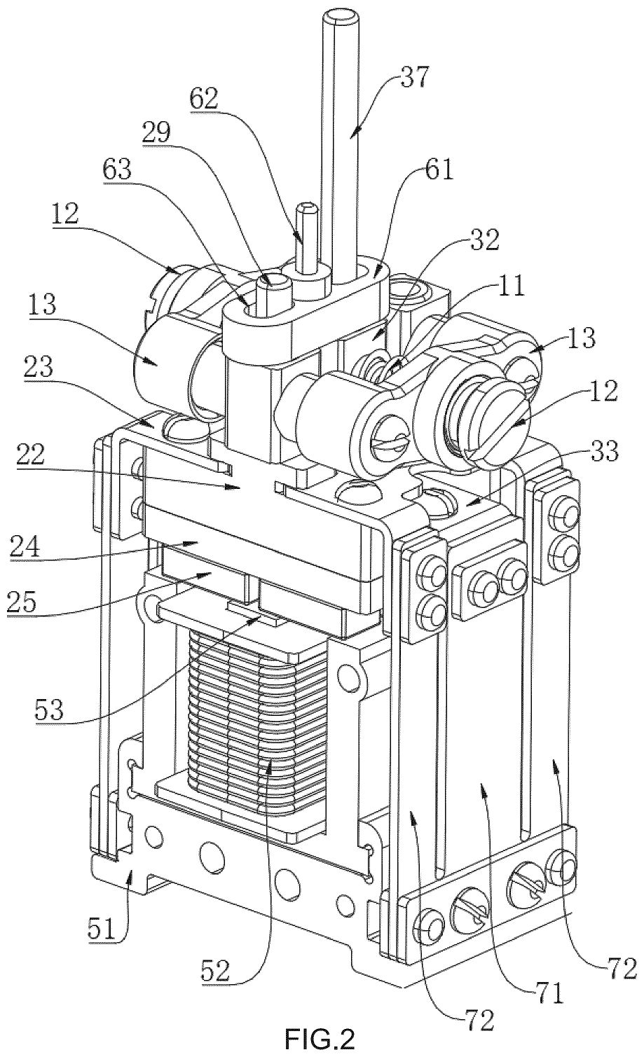

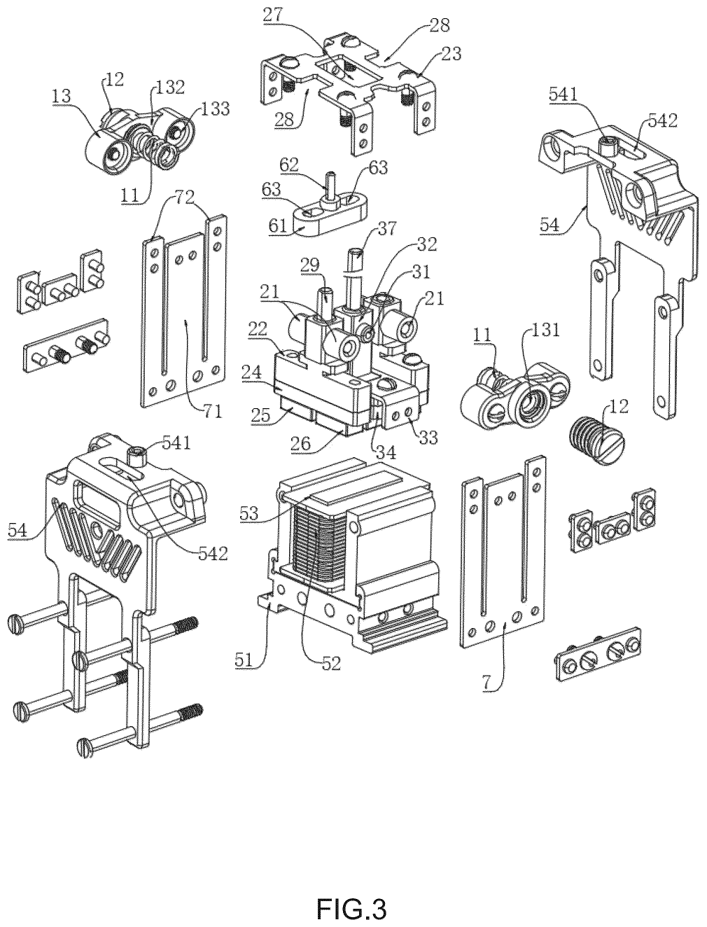

As shown in FIGS. 2 and 3, the inner mover 3 includes an inner swinging member 32, and the outer mover 2 includes an outer swinging member 22. In this embodiment, two outer movers 2 are provided, the inner mover 3 is arranged between the two outer movers 2, the inner mover 3 is provided with a first abutment position 31, and the elastic force support member 13 is provided with a second abutment position 132, elastic force fixing holes 133 are formed on both sides of the second abutment position 132, an elastic force fixing groove 21 is formed on the outer mover 2, the elastic member 11 is fixed between the first abutment position 31 and the second abutment position 132 and the elastic force support member 13 is fixedly connected to the outer mover 2 by bolting into or screwing into the elastic force fixing holes 133 and the elastic force fixing groove 21,. When the moving blade 4 is arranged on an upper end of the inner swinging member 32 and drives the inner swinging member to swing leftward and rightward, a sum of weights of the moving blade 4 and the inner mover 3 is balanced against a sum of weights of the two outer movers 2 and the two elastic force adjustment devices 1, that is, a sum of weights of the moving blade 4 and the inner mover 3 is set to A, a sum of weights of the two outer movers 2 and the two elastic force adjustment devices 1 is set to B, A is approximately equal to B, and an absolute value of (A-B)/A is ≤⅕; more preferably, a total weight of the moving blade 4 is set to C, a total weight of the inner mover 3 is set to D, C is approximately equal to D, and an absolute value of (C-D)/C is ≤⅕, which can prevent lateral torsional vibrations caused by weight imbalance during operation of the moving blade 4 driven by the inner mover 3, stabilizing a vibration frequency and improving user experience. When replacement of the moving blade 4 results in weight imbalance, the coefficient adjustment member 12 with different lengths can be replaced to maintain relative weight balance and reduce overall vibration of the motor.

As shown in FIG. 3, the stator device 5 includes a bottom bracket 51, a coil 52, a stator 53, and a main bracket 54, where the main bracket 54 is provided with two, which are respectively fixed on both sides of the bottom bracket 51, the coil 52 and the stator 53 are arranged on the bottom bracket 51, the inner mover 3 and the outer mover 2 are provided with a bias swing limit member 61 and a bias swing limit rod 62, a limit fixing hole 541 for fixing the bias swing limit rod 62 is formed on the main bracket 54, such that the bias swing limit member 61 and the bias swing limit rod 62 are rotatably and movably connected to the main bracket 54; and the inner swinging member 32 is provided with an inner output shaft 37, the outer swinging member 22 is provided with an outer output shaft 29, two elliptical holes 63 are symmetrically formed on two ends of the bias swing limit member 61, and the two elliptical holes 63 on the bias swing limit member 61 are respectively sleeved on the inner output shaft 37 of the inner swinging member 32 and the outer output shaft 29 of the outer swinging member 22. When the inner swinging member 32 and the outer swinging member 22 perform reciprocal movements relative to each other, the bias swing limit member 61 rotates on an outer periphery of the bias swing limit rod 62, realizing a linkage between the inner mover 3 and the outer mover 2.

As shown in FIGS. 1-3, the main bracket 54 is provided with a first limit swing zone 542, the two main brackets 54 are assembled together to form a total of three first limit swing zones 542, and the three first limit swing zones 542 are arranged in upper and lower positions corresponding to the outer output shaft 29 of the outer swinging member 22 and the inner output shaft 37 of the inner swinging member 32, respectively, the inner output shaft 37 extends from a bottom to a top of the first limit swing zones 542 and is connected to the moving blade 4 to drive the moving blade 4 to swing, such that the outer output shaft 29 and the inner output shaft 37 do not come into contact with the first limit swing zones 542 when swinging back and forth, noise is prevented and user experience is improved.

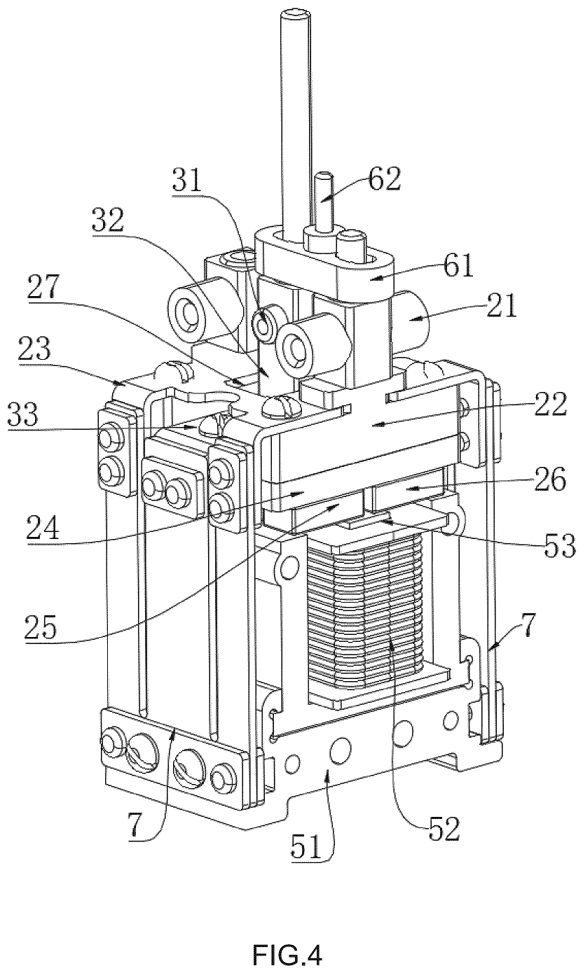

As shown in FIGS. 3-4, the inner mover 3 further includes an inner bracket 33 that is fixedly connected to the inner mover in an integral manner, and the outer mover 2 further includes an outer bracket 23 that is fixedly connected to the outer mover in an integral manner. The outer bracket 23 is provided with an outer avoidance groove 28, the outer mover 2 partially passes through the outer avoidance groove 28, the inner bracket 33 is arranged below the outer bracket 23, the outer bracket 23 is further provided with a second limit swing zone 27, and the inner swinging member 32 partially passes through the second limit swing zone 27 to achieve position avoidance. Since stainless steel can be thinner and withstand strong force during high-frequency swing of the motor without breaking or deforming, and stainless steel is cost-effective and easy to purchase on the market, the outer bracket 23 and the inner bracket 33 are both made of stainless steel with a thickness of ≤1.2 mm. The thinner stainless steel brackets can reduce an overall size of the motor while independently playing a role in carrying and fixing the movers and connecting the spring pieces, which can greatly extend an overall service life of the motor.

Specifically, a lower end of the spring piece 7 is fixedly connected to the bottom bracket 51, two spring pieces 7 are provided and arranged on both sides of the inner mover 3 and the outer mover 2; each of the spring pieces 7 includes an inner spring plate 71 and an outer spring plate 72, an upper end of the inner spring plate 71 is fixedly connected to the inner bracket 33, two outer spring plates 72 are provided and correspond to the two outer movers 2, respectively; upper ends of the two outer spring plates 72 are fixedly connected to the outer bracket 23, the outer spring plates 72 are symmetrically arranged on both sides of the inner spring plate 71, lower ends of the inner spring plate 71 and the outer spring plates 72 are integrally connected, which is conducive to sheet molding, simplifies material management, and fixes relative positions of the plates for easy assembly and mass production.

As shown in FIG. 3 and FIGS. 5-11, the inner mover 3 further includes an inner magnetic yoke 34, a first inner magnet 35 and a second inner magnet 36; the outer mover 2 further includes an outer magnetic yoke 24, a first outer magnet 25 and a second outer magnet 26; and the inner magnetic yoke 34, the first inner magnet 35 and the second inner magnet 36 are fixedly arranged at a lower end of the inner swinging member 32, the outer magnetic yoke 24, the first outer magnet 25 and the second outer magnet 26 are fixedly arranged at a lower end of the outer swinging member 22, magnetic poles of the first inner magnet 35 and the first outer magnet 25 are opposite, and magnetic poles of the second inner magnet 36 and the second outer magnet 26 are opposite. For example, when the first inner magnet 35 is set to a North (N) pole and the second inner magnet 36 is set to a South (S) pole, the first outer magnet 25 is set to a South (S) pole and the second outer magnet 26 is set to a North (N) pole, alternating current is supplied to the coil 52 to generate a magnetic field, a single magnetic pole forms at a certain moment at an upper end of the stator 53. Since the magnetic poles of the first inner magnet 35 and the second inner magnet 36 are set opposite to those of the first outer magnet 25 and the second outer magnet 26, the single magnetic pole generated by the alternating current at the moment has opposite magnetic effects on the first inner magnet 35 and the second inner magnet 36, as well as on the first outer magnet 25 and the second outer magnet 26, for example, when the first inner magnet 35 and the second inner magnet 36 tend to swing to a right, the first outer magnet 25 and the second outer magnet 26 tend to swing to a left. As the alternating current changes a current direction, the upper end of the stator 53 becomes a magnetic pole opposite to the previous magnetic polarity after the current direction is changed, such that the first inner magnet 35 and the second inner magnet 36 change movement directions and swing to the left, while the first outer magnet 25 and the second outer magnet 26 swing to the right. The magnetic levitation motor 100 driven by the alternating current has small starting force and a fast current conversion frequency, therefore, driven by the first inner magnet 35 and the second inner magnet 36, as well as the first outer magnet 25 and the second outer magnet 26, the inner swinging member 32 and the outer swinging member 22 also swing quickly in a staggered manner.

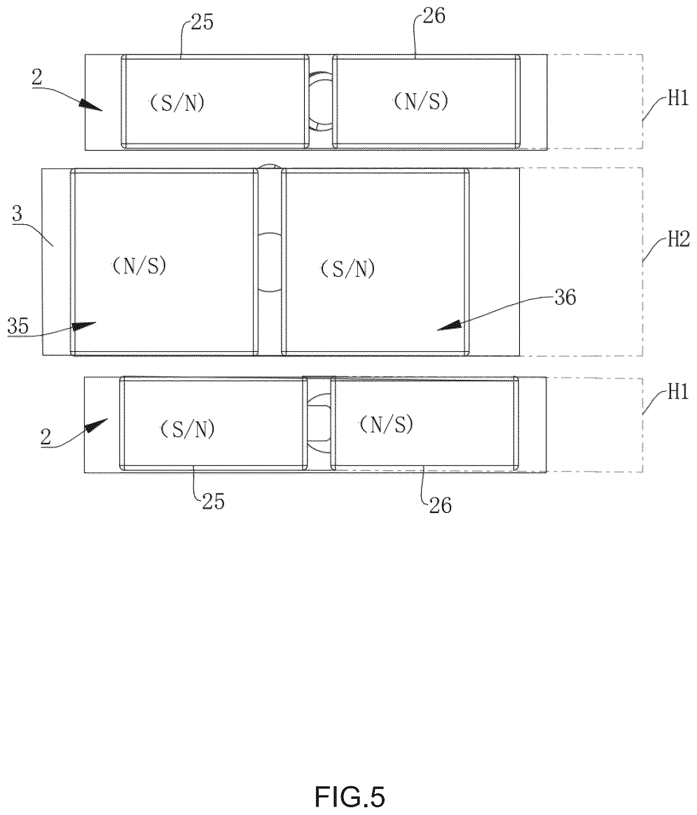

As shown in FIG. 5, a width H1 of the outer mover 2 is approximately half of a width H2 of the inner mover 3. When the inner mover 3 is arranged between the two outer movers 2, a combined width 2H1 is equal to or close to the width H2, which further reduces the likelihood of lateral torsional vibrations of the moving blade 4 driven by the inner mover 3 during operation due to weight imbalance, thereby increasing frequency of balanced vibrations and effectively improving the user experience.

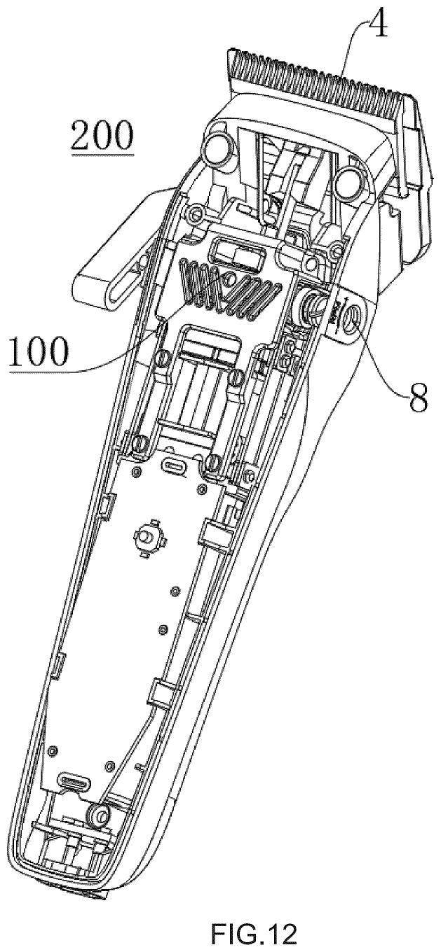

As shown in FIG. 12, the magnetic levitation motor 100 featuring speed adjustment that is provided with the elastic force adjustment device 1 and capable of adjusting the pressure value of the elastic member 11 is applied to an electric appliance such as a hair trimmer 200, an electric shaver, and a hair clipper. Two second coefficient adjustment holes 8 are formed on both sides of a housing of the hair trimmer 200 and penetrate into the elastic force adjustment device 1. When the magnetic levitation motor 100 is installed on the hair trimmer 200, the two second coefficient adjustment holes 8 correspond to but do not come into contact with the two elastic force adjustment devices 1 respectively. When it is necessary to adjust a coefficient of the elastic member 11, a screw driver or other tools can be inserted into the second coefficient adjustment holes 8 from an outside to be in contact with the coefficient adjustment member 12 of each of the elastic force adjustment devices 1, the coefficient adjustment member 12 is directly adjusted to achieve tightness. A sealing cover can also be arranged on each of the second coefficient adjustment holes 8.

In addition, two coefficient adjustment protection switches and two coefficient adjustment gears can be arranged on the second coefficient adjustment holes 8. Serving as the protective devices for the coefficient adjustment gears, the coefficient adjustment protection switches needs to perform an unlocking action when in use to prevent children from touching or accidentally touching the coefficient adjustment gears when in use, such that the safety performance is improved. When the coefficient adjustment protection switches are unlocked, the coefficient adjustment gears are in contact with the coefficient adjustment member 12 and directly adjust the coefficient of the elastic element 11. When a desired coefficient is adjusted, the coefficient adjustment protection switches are locked, in which case, the coefficient adjustment gears are away from the coefficient adjustment member 12, avoiding affecting the use of the magnetic levitation motor 100 due to contact, which does not require the use of the screwdriver or other tools to insert from the outside to operate the coefficient adjustment member 12, without being limited by usage scenarios, such that the motor can be applied in various usage scenarios, is more flexible and convenient to operate, exhibits high protective performance, and is highly practical.

For those skilled in the art, it is apparent that the present disclosure is not limited to details of the exemplary embodiments, and the present disclosure can be implemented in other specific forms without departing from the spirit or basic features of the present disclosure. Therefore, the embodiments should be regarded as illustrative and non-restrictive no matter from which point of view. The scope of the present disclosure is defined by the appended claims rather than the above specification, and therefore, it is intended that all changes which fall within the meaning and scope of equivalency of the claims are embraced in the present disclosure. Any reference numeral in the claims should not be construed as limiting the related claims.

Furthermore, it should be understood that although the description is described according to implementations, each implementation does not include only one independent technical solution, the description is for clarity only, and those skilled in the art should take the description as a whole, the technical solutions in the various embodiments may be appropriately combined to form other implementations understandable by those skilled in the art.

What is claimed is:

1. A speed-adjustable magnetic levitation motor, comprising an elastic force adjustment device, an outer mover, and an inner mover, a magnetic pole of a lower end of the outer mover is arranged opposite to that of a lower end of the inner mover, and the elastic force adjustment device is fixedly arranged on the outer mover; and the elastic force adjustment device comprises an elastic member, a coefficient adjustment member, and an elastic force support member, the coefficient adjustment member is detachably connected to the elastic force support member, one end of the elastic member abuts against the inner mover, the other end of the elastic member abuts against the coefficient adjustment member, and a pressure value of elastic member can be adjusted by adjusting a distance between the coefficient adjustment member on the elastic force support member and the outer mover.

2. The speed-adjustable magnetic levitation motor according to claim 1, wherein a first coefficient adjustment hole is formed on the elastic force support member, and the coefficient adjustment member adjusts a distance between the coefficient adjustment member on the elastic force support member and the outer mover through the first coefficient adjustment hole.

3. The speed-adjustable magnetic levitation motor according to claim 2, wherein two outer movers are provided, the inner mover is arranged between the two outer movers, the inner mover is provided with a first abutment position, the elastic force support member is provided with a second abutment position, elastic force fixing holes are formed on both sides of the second abutment position, and an elastic force fixing groove is formed on the outer mover.

4. The speed-adjustable magnetic levitation motor according to claim 3, wherein the inner mover comprises an inner swinging member, and the outer mover comprises an outer swinging member; and a stator device is arranged below the inner mover, the stator device comprises a bottom bracket, a coil, a stator and a main bracket, the inner mover and the outer mover are provided with a bias swing limit member and a bias swing limit rod, the inner swinging member is provided with an inner output shaft, the outer swinging member is provided with an outer output shaft, two elliptical holes are symmetrically formed on two ends of the bias swing limit member, and the main bracket is provided with a limit fixing hole and a first limit swing zone.

5. The speed-adjustable magnetic levitation motor according to claim 4, wherein the inner mover further comprises an inner bracket, the outer mover further comprises an outer bracket, the outer bracket is provided with an outer avoidance groove, the outer bracket is further provided with a second limit swing zone, the first limit swing zones correspond to the second limit swing zone and the outer avoidance groove in a vertical direction, the inner swing member is fixedly connected to the inner bracket, the outer swing member is fixedly connected to the outer bracket, and the outer bracket and the inner bracket are both made of stainless steel with a thickness of ≤1.2 mm.

6. The speed-adjustable magnetic levitation motor according to claim 5, wherein both sides of the outer mover and the inner mover are provided with spring pieces, two spring pieces are provided, each of the spring pieces comprises an inner spring plate and an outer spring plate, an upper end of the inner spring plate is fixedly connected to the inner bracket, and an upper end of the outer spring plate is fixedly connected to the outer bracket.

7. The speed-adjustable magnetic levitation motor according to claim 6, wherein the inner mover further comprises an inner magnetic yoke, a first inner magnet and a second inner magnet, and the outer mover further comprises an outer magnetic yoke, a first outer magnet and a second outer magnet, the inner magnetic yoke; and the first inner magnet and the second inner magnet are fixedly arranged at a lower end of the inner swinging member, the outer magnetic yoke, the first outer magnet and the second outer magnet are fixedly arranged at a lower end of the outer swinging member, magnetic poles of the first inner magnet and the first outer magnet are opposite, and magnetic poles of the second inner magnet and the second outer magnet are opposite.

8. A hair trimmer, comprising the speed-adjustable magnetic levitation motor according to claim 4, wherein two elastic force adjustment devices are provided and correspond to two outer movers one by one, a moving blade is arranged on an upper end of the inner swinging member, a total weight of the moving blade is set to C, a total weight of the inner mover is set to D, and an absolute value of (C-D)/C is ≤⅕; and a sum of weights of the moving blade and the inner mover is set to A, a sum of weights of the two outer movers and the two elastic force adjustment devices is set to B, and an absolute value of (A-B)/A is ≤⅕.

9. The hair trimmer according to claim 8, wherein two second coefficient adjustment holes are formed on the hair trimmer, and the two second coefficient adjustment holes correspond to but do not come into contact with the two elastic force adjustment devices respectively.

10. The hair trimmer according to claim 9, wherein a coefficient adjustment protection switch and a coefficient adjustment gear are arranged on the second coefficient adjustment holes.
